(19) United States
(12) Patent Application Publication
(10) Pub. No.: US 2020/0096139 A1
(43) Pub. Date: Mar. 26, 2020

(54) Non-Bursting Pipe and Method of Manufacturing Same

(71) Applicant: Afzal M. Chaudhry, Somerset, NJ (US)

(72) Inventor: Afzal M. Chaudhry, Somerset, NJ (US)

(21) Appl. No.: 16/143,081

(22) Filed: Sep. 26, 2018

(51) Int. Cl. F16L 9/147; F16L 9/17

(52) U.S. Cl. CPC F16L 9/147; F16L 9/133; F16L 9/17

(57) ABSTRACT

The present invention is a non-bursting pipe which has an inner layer of copper and an outer layer of high carbon steel. The pipe is shaped such that its area of cross-section can increase under the pressure of expanding water when water cools below 4° C. When water turns into ice at freezing temperature in severe winter the area of cross-section of the pipe can increase enough to accommodate the increase in volume of water when it turns into ice. This saves the pipe from bursting and causing any damage to properties.

When in warm weather ice inside the pipe melts the area of cross-section of the pipe decreases by spring-like action of the high carbon steel layer. The non-bursting pipe is now ready to face another severe winter and to save the water supply from any damage.

### BACKGROUND OF THE INVENTION

The present invention of non-bursting pipe relates to the water pipes which burst in severe winter when water freezes in the pipes. The bursting of water pipes can cause property damage besides the damage to the water supply. The repair of property and the water supply can cost great deal of money. A non-bursting pipe is therefore needed to avoid such damage to the water supply and the properties SUMMARY OF THE INVENTION

The present invention, namely non-bursting pipe, can be made from a regular water pipe which has a circular cross-sectional view by shaping it in such a way that it has less area of cross-section than the regular pipe when water is flowing at normal temperature. In cold weather when water in the pipe cools below 4° C., water expands and at freezing temperature it can expand as much as 10%. The high pressure of the expanding water can open up the pipe to increase the area of cross-section of the pipe thereby increasing the space inside the pipe to accommodate the expansion of water when it turns into ice. This can save the pipe from bursting and damaging water supply and any property.

### BRIEF DESCRIPTION OF THE DRAWINGS

To better understand the present invention, the objects and the advantages thereof, reference is made to the ensuing descriptions taken in connection with the accompanying drawings briefly described as follows.

FIG. 1 shows the cross-sectional view of the non-bursting pipe when water is flowing through the pipe at normal temperature. The pipe is made of two or more layers of metal having different properties. At normal temperature the area of cross-section of the pipe is about 15 to 20% less than the area of cross-section of the pipe when water expands as it freezes in the pipe in a severe winter.

FIG. 2 shows the increased area of cross-section of the non-bursting pipe when water expands as it turns into ice at freezing temperature. The increased area of cross-section of the pipe can help accommodate the increased volume of the water when it turns into ice.

### DETAILED DESCRIPTION OF PREFERRED EMBODIMENTS

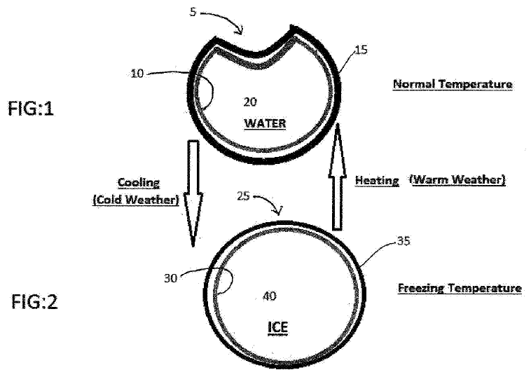

Preferred embodiments of the present invention and their advantages may be understood by referring to FIG. 1-2, wherein reference numerals refer to different elements.

FIG. 1 Number 5 shows the cross-sectional view of the non-bursting pipe. 10 shows the interior layer of pipe which is made of copper and 15 shows the outer layer of the pipe which is made of high carbon steel. 20 shows the area of cross-section of the pipe.

FIG. 2 Number 25 shows the cross-sectional view of non-bursting pipe at freezing temperature when water has turned into ice. 30 shows the copper layer and 35 shows the high carbon steel layer of the pipe. 40 shows the increased area of cross-section of the pipe when water freezes.

The non-bursting pipe is shaped such that the area of cross-section 20 is about 15 to 20% less than the area of cross-section 40.

FIG. 1 shows the area of cross-section of the non-bursting pipe when water is flowing through the pipe at normal temperature. When water cools to a temperature of 4° C. the density of water is maximum. As the water cools below 4° C. water starts expanding and the density of water starts decreasing until at freezing temperature when water turns into ice the density of water is approximately 10% less than the density of water at 4° C. Under the high pressure of expanding water the area of cross-section of the pipe increases. FIG. 2 shows the cross-sectional view of the pipe when water has turned into ice. As the temperature increases in warm weather ice in the pipe starts melting and the area of cross-section of the pipe starts decreasing due to the spring like action of the high carbon steel layer. At normal temperature, therefore, the area of cross-section of the pipe decreases to that shown in FIG. 1.

### Method of Manufacturing

Non-bursting pipe can be manufactured by shaping and welding a metal sheet having layers of copper and high carbon steel.

The present invention has been described using specific embodiments for the purpose of illustration only. It will be readily apparent to one of the ordinary skill in the art, however, that the principles of the invention can be embodied in other ways. Therefore, the invention should not be regarded as being limited in scope to the specific embodiments disclosed herein, but instead as being fully commensurate in scope with the following claims.

1. A non-bursting pipe comprising:
a. An inside layer of copper
b. An outer layer of high carbon steel
c. The pipe is shaped such that the area of cross-section of the pipe is less than the area of cross-section of a regular pipe when water flows at normal temperature (see FIG. 1).

2. In the non-bursting pipe of claim 1
a. The area of cross-section of the pipe increases under pressure of the expanding water when water cools below 4° C.
b. The area of cross-section of the pipe increases further when water freezes in severe winter.
c. The increased area of cross-section makes more space inside the pipe for frozen water and this saves the pipe from bursting (see FIG. 2).

3. In the non-bursting pipe of claim 2
a. When ice starts melting in warm weather the volume of water decreases and the area of cross-section of the pipe starts decreasing due to the spring like action of high carbon steel layer.
b. When ice has completely melted the area of the cross-section of the pipe becomes the same as shown in FIG. 1.
c. The non-bursting pipe is now ready to face another severe winter
